(19) United States
(12) Patent Application Publication
(10) Pub. No.: US 2012/0124274 A1
(43) Pub. Date: May 17, 2012

(54) Automatic guided flash disk and its operation method

(75) Inventors: Yu Hong-Chi, Kaohsiung City (TW); Chang Mao-Ting, Kaohsiung City (TW)

(73) Assignee: WALTON ADVANCED ENGINEERING INC., Kaohsiung (TW)

(21) Appl. No.: 13/064,835

(22) Filed: Apr. 20, 2011

(30) Foreign Application Priority Data
Nov. 15, 2010 (TW) 099139222

(51) Int. Cl. G06F 12/00

(52) U.S. Cl. 711/103; 711/E12.008

(57) ABSTRACT

The present invention provides an automatic guided flash disk and its operation method. When the present invention is plugged into a computer's port by a user, a request to connect a Human Interface Device (HID) is issued to a computer by a human interface device module in a control unit and the computer's status is determined by a system status decision module and taken as references of a character auto-entering module which regularly enables the computer's resident programs or activates a website by entering at least one character frequency.

### BACKGROUND OF THE INVENTION

1) Field of the Invention

The present invention relates to an automatic guided flash disk and its operation method, especially to a device, which is provided with USB featuring smallness, thinness, and portability and is connected to a computer for computer programs automatically executed or characters automatically entered, and an operation method for this device.

2) Description of the Prior Art

Referring to FIGS. 1A and 1B which indicate a USB flash disk (40) manufactured in prior arts and provided with a substrate (41), a plurality of electronic devices (42), a plurality of metal contacts (43) for a male connector conforming to a USB data transfer interface, and a package body (44) wherein the metal contacts (43) are located on an outer surface (411) of the substrate (41) and the electronic device (42) comprises one or more memory chips (421) and a control element (422) installed on an inner surface (412) of the substrate (41) and electrically connected to metal contacts (43). With metal contacts (43) electrically connected to a computer's port, the control element (422) is able to control data, which is saved in a computer or a memory chip (421), to be accessed, copied, deleted, or moved.

However, a light, thin, short, and small USB flash disk is not thoroughly applied to e-marketing via Internets because the said USB flash disk (40) is incapable of automatically executing computer programs or Internet access. Against this background, it is necessary to offer a better solution to correct shortages hereinabove.

### SUMMARY OF THE INVENTION

To solve issues mentioned above, the present invention provides an automatic guided flash disk and its operation method. When the present invention is plugged into a computer's port by a user, a request to connect a Human Interface Device (HID) is issued to a computer by a human interface device module in a control unit and the computer's status is determined by a system status decision module and taken as references of a character auto-entering module which regularly enables the computer's resident programs or activates a website by entering at least one character.

To reach the said purpose, the present invention has the principal technical measures embodied with the following techniques. The steps to operate the present invention of an automatic guided flash disk are: (1) Step a: A flash disk plugged into a port on a computer; (2) Step b: Power connected; (3) Step c: A request to connect a Human Interface Device (HID) actively issued to a computer by a human interface device module in the flash disk's control unit; (4) Step d: A request for obtaining an original signal state of “Caps Lock” or “Num Lock” and then a request for a signal of “Caps Lock” or “Num Lock” switched issued to a computer by a system status decision module in the flash disk's control unit and then, the system status decision module received a response from the computer; (5) Step e: Calculation of a unit interval from the request of switching a signal of “Caps Lock” or “Num Lock” to a response of the computer received by the system status decision module; (6) Step f: Status of the computer determined by the system status decision module according to the calculated unit interval; (7) Step g: At least one character entered by a character auto-entering module in the flash disk's control unit to normally activate resident programs of the computer as per the computer's status determined in Step f.

The purposes and the technical issues with respect to the present invention are further embodied with the following technical measures.

In the said operation method of an automatic guided flash disk, a constant cyclic process from Step d to Step g will not be stopped until at least one character is entered in Step g.

In the said operation method of an automatic guided flash disk, the computer recovers the original signal state of “Caps Lock” or “Num Lock” by the system status decision module when at least one character was entered in Step g.

In the said operation method of an automatic guided flash disk, the character auto-entering module described in Step g is capable of entering one command or one website address to activate a browser.

In the said operation method of an automatic guided flash disk, the character auto-entering module described in Step g is able to enter one password.

The present invention of an automatic guided flash disk has an integrated circuit module which comprises a substrate, at least a memory chip, at least a control element and a plurality of metal contacts wherein the memory chip and the control element are installed on an inner surface of the substrate, the metal contacts are installed on an outer surface of the substrate for connection to a port on a computer, and the control element has a control unit which comprises a human interface device module, a system status decision module, and a character auto-entering module.

The purposes and the technical issues with respect to the present invention are further delivered with the following technical measures.

In the said automatic guided flash disk, the metal contacts are compatible to a male connector with at least one of the following data transfer interfaces such as Universal Serial Bus (USB), Mini Universal Serial Bus (Mini USB), or Micro Universal Serial Bus (Micro USB).

In the said automatic guided flash disk, the memory chip, the control element and the metal contacts are electrically connected one another via electronic circuits on the substrate.

In the said automatic guided flash disk, an outer length (L) and an outer width (W) are less than 12.5 mm and 11.5 mm, respectively.

Compared with the prior arts, the present invention is effective in a computer's resident programs or a website normally activated owing to the computer's system status determined by the system status decision module with the present invention plugged into the computer's port by a user.

### BRIEF DESCRIPTIONS OF THE DRAWINGS

FIG. 1A is the perspective view of a USB device manufactured in prior arts.

FIG. 1B is the sectional view of a USB device manufactured in prior arts.

FIG. 2 is the perspective view for the principal embodiment of the present invention of an automatic guided flash disk.

FIG. 3 is the sectional view for the principal embodiment of the present invention of an automatic guided flash disk.

FIG. 4 is the sectional view with the present invention of an automatic guided flash disk plugged into a computer's port.

FIG. 5 is the block diagram for the operation method in the principal embodiment of the present invention of an automatic guided flash disk.

FIG. 6 is the flow diagram for the operation method in the principal embodiment of the present invention of an automatic guided flash disk.

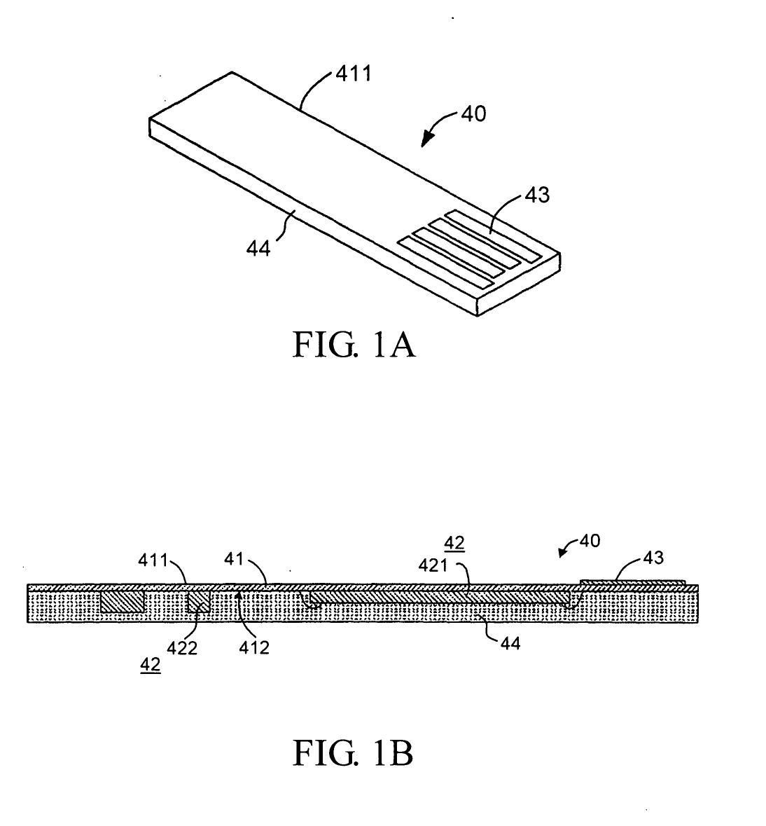

### DETAILED DESCRIPTIONS OF THE PREFERRED EMBODIMENTS

For objects, characteristics, and effects obviously and easily understood, the preferred embodiments of the present invention are particularly interpreted as follows:

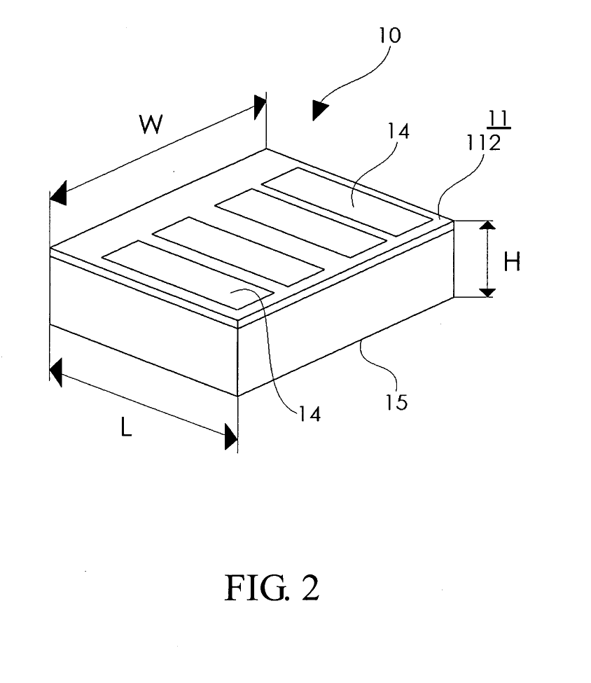

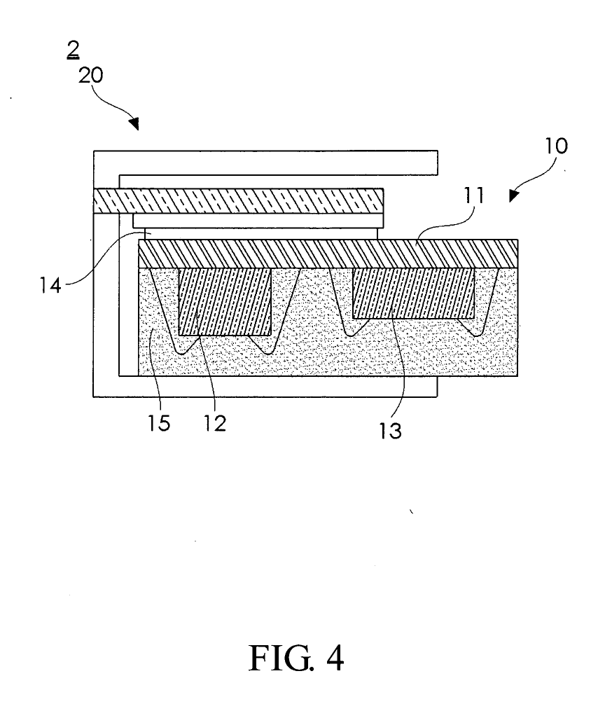

The principal embodiment for the present invention of an automatic guided flash disk is shown from FIG. 2 to FIG. 6. Referring to FIGS. 2, 3, and 4 which indicate the present invention has an integrated circuit module (10) encased in a Chip-On-Board (COB) package and comprising a substrate (11), at least a memory chip (12), at least a control element (13), and a plurality of metal contacts (14) wherein the memory chip (12) and the control element (13) are installed on an inner surface (111) of the substrate (11) and the metal contacts (14) are installed on an outer surface (112) of the substrate (11) for connection to a port (20) on a computer (2).

Furthermore, the substrate (11) is usually a high-density double-sided multi-layer printed circuit board with circuits (not shown in figures) developed inside as an interface for transmit of electricity and the memory chip (12) as well as the control element (13) electrically connected to the metal contacts (14).

The memory chip (12) and the control element (13) can be electrically connected to the substrate (11) with a wire bonding or a flip chip technique (not shown in figures).

The memory chip (12) used for data saving can be FLASH memory, Static-Random-Access-Memory (SRAM), Application-Specific-Integrated-Circuit (ASIC), Application-Specific-Integrated-Circuit (ASIC), memory chip, or Synchronous-Dynamic-Random-Access-Memory (SDRAM).

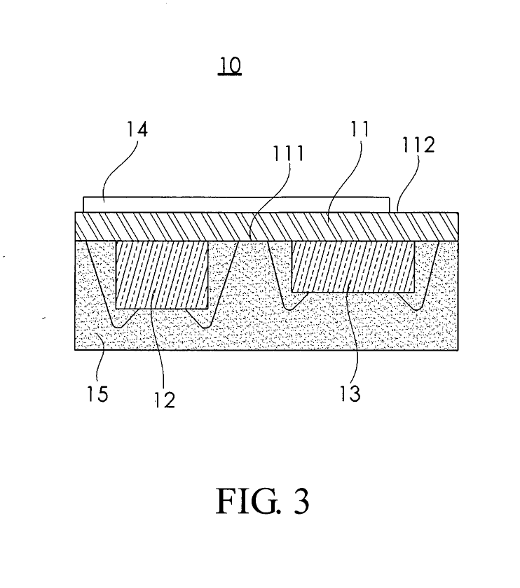

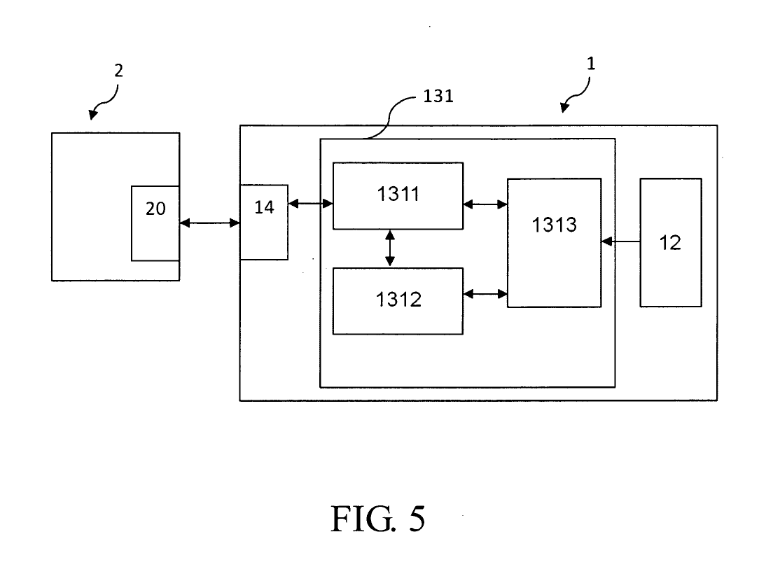

Referring to FIG. 3 and FIG. 5 which indicate the control element (13) has a control unit (131) comprising a human interface device module (1311), a system status decision module (1312) and a character auto-entering module (1313). In this regard, the human interface device module (1311), the system status decision module (1312) and the character auto-entering module (1313) are electrically connected one another.

When the present invention is plugged into a port of one computer, a request to connect a Human Interface Device (HID) is issued to the computer by the human interface device module (1311) which is a simulative keyboard in this embodiment;

The system status decision module (1312) is used to issue a request to the computer (2) for obtaining an original signal state of “Caps Lock” or “Num Lock” and then to issue a request to the computer (2) for a signal of “Caps Lock” or “Num Lock” switched, and then, the system status decision module (1312) received a response from the computer (2) and then the system status decision module (1312) calculate a unit interval from the request of switching the signal of “Caps Lock” or “Num Lock” issued to a response of the computer (2) received, and decide the status of the computer (2) according to the unit interval;

The character auto-entering module (1313) is used to enter at least one character frequency and normally activate resident programs of the computer in compliance with the determined status of the computer (2); in this regard, the at least one character automatically entered via an electronic circuit design of the character auto-entering module (1313) is built in the memory chip (12) and transmitted to the computer (2) through the human interface device module (1311).

The at least one character entered via the character auto-entering module (1313) is a hot key based on the computer's status as a standard for at least one character frequency entered and is used to normally enable resident programs of the computer such as a command to activate a browser. Additionally, characters entered could be a website address, which corresponds to a website with a browser activated, or a password.

Referring to FIG. 3 again which indicates an inner surface (111) of the substrate (11) preferably developed to be a package body (15) encasing the memory chip (12) and the control element (13). Furthermore, passive components (not shown in the figure) necessary to the integrated circuit module (10) are also installed on the inner surface (111) of the substrate (11) and encased inside the package body (15).

Referring to FIG. 2 which indicates the length (L) and the width (W) of the present invention are less than 12.5 mm and 11.5 mm, respectively.

In addition, the metal contacts (14) are compatible to a male connector with at least one of the following data transfer interfaces such as Universal Serial Bus (USB), Mini Universal Serial Bus (Mini USB), or Micro Universal Serial Bus (Micro USB), and described with a male connector (Series A) compatible to the data transfer interface of Universal Serial Bus (USB) in this embodiment.

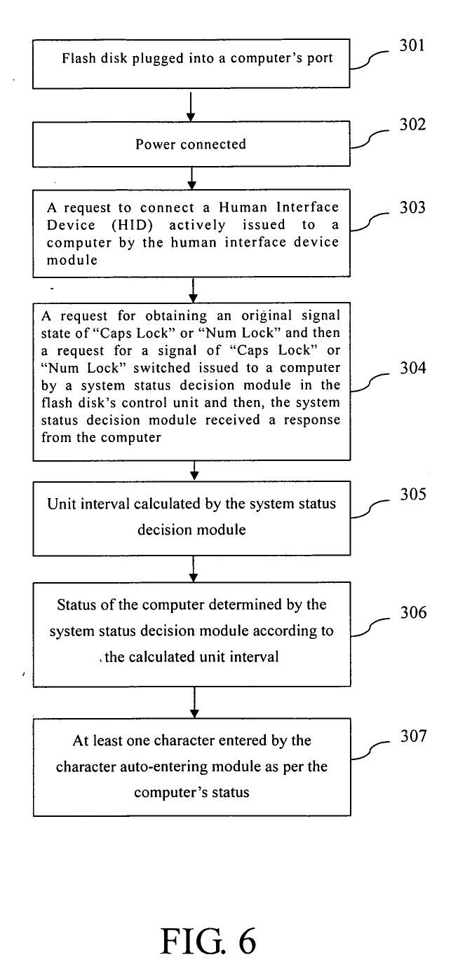

Referring to FIG. 6 which indicates an operation method in the principal embodiment of the present invention: (1) Step a: A flash disk plugged into a port on a computer (301); (2) Step b: Power connected (302); (3) Step c: A request to connect a Human Interface Device (HID) actively issued to a computer by a human interface device module in the flash disk's control unit (303); (4) Step d: A request for obtaining an original signal state of “Caps Lock” or “Num Lock” and then a request for a signal of “Caps Lock” or “Num Lock” switched issued to a computer by a system status decision module in the flash disk's control unit and then, the system status decision module received a response from the computer (304); (5) Step e: Calculation of a unit interval from the request of switching a signal of “Caps Lock” or “Num Lock” to a response of the computer received by the system status decision module (305); (6) Step f: Status of the computer determined by the system status decision module according to the calculated unit interval (306); (7) Step g: At least one character entered by a character auto-entering module in the flash disk's control unit to normally activate resident programs of the computer as per the computer status determined in Step f (307).

Preferably, a constant cyclic process from Step d to Step g will not be stopped until at least one character is entered in Step g. In detail, the computer recovers the original signal state of “Caps Lock” or “Num Lock” by the system status decision module when at least one character was entered in Step g.

With the said descriptions summarized, the present invention has an integrated circuit module in which the substrate is provided with a control element comprising a human interface device module, a system status decision module, and a character auto-entering module and automatically and normally activating resident programs of the computer based on steps for execution of modules described herein to enter either characters (for instance, a website address that directly corresponds to a website with a browser enabled) or a password when the present invention is plugged into the computer's port. Accordingly, the present invention that is different from general conventional flash disks but referred to as creative work among similar products meets patentability and is applied for the patent.

It must be stressed that the said descriptions are only the preferred embodiments of the present invention and any equivalent change in descriptions, claims, or drawings of the present invention is under protection of the technical scope of the present invention which accordingly depends on claims specified hereinafter.

What is claimed is:

1. An operation method for an automatic guided flash disk, comprising:
Step a: A flash disk plugged into a port on a computer (301);
Step b: Power connected (302);
Step c: A request to connect a Human Interface Device (HID) actively issued to a computer by a human interface device module in the flash disk's control unit (303);
Step d: A request for obtaining an original signal state of “Caps Lock” or “Num Lock” and then a request for a signal of “Caps Lock” or “Num Lock” switched issued to a computer by a system status decision module in the flash disk's control unit and then, the system status decision module received a response from the computer(304);
Step e: Calculation of a unit interval from the request of switching a signal of “Caps Lock” or “Num Lock” to a response of the computer received by the system status decision module (305);
Step f: Status of the computer decided by the system status decision module according to the calculated unit interval (306);
Step g: At least one character entered by a character auto-entering module in the flash disk's control unit to normally activate resident programs of the computer as per the computer's status determined in Step f (307).

2. The operation method for an automatic guided flash disk according to claim 1 wherein a constant cyclic process from Step d to Step g will not be stopped until at least one character is entered in Step g.

3. The operation method for an automatic guided flash disk according to claim 2 wherein the computer recovers the original signal state of “Caps Lock” or “Num Lock” by the system status decision module when at least one character was entered in Step g.

4. The operation method for an automatic guided flash disk according to claim 1 wherein the character auto-entering module described in Step g is used to enter either a commend to enable a browser or a website address.

5. The operation method for an automatic guided flash disk according to claim 1 wherein the character auto-entering module described in Step g is used to enter a password.

6. An automatic guided flash disk (1), comprising:
An integrated circuit module (10) which comprises a substrate (11), at least a memory chip (12), a control element (13) and a plurality of metal contacts (14) wherein the memory chip (12) and the control element (13) are installed on an inner surface (111) of the substrate (11) and the metal contacts (14) are installed on an outer surface (112) of the substrate (11) for connection to a port (20) of a computer (2); the control element (13) has a control unit (131) which comprises a human interface device module (1311), a system status decision module (1312) and a character auto-entering module (1313).

7. The automatic guided flash disk according to claim 6 wherein the metal contacts are compatible to a male connector with at least one of the following data transfer interfaces such as Universal Serial Bus (USB), Mini Universal Serial Bus (Mini USB), or Micro Universal Serial Bus (Micro USB).

8. The automatic guided flash disk according to claim 6 wherein the memory chip (12), the control element (13) and the metal contacts (14) are electrically connected one another via electronic circuits on the substrate (11).

9. The automatic guided flash disk according to claim 6 wherein the outer length (L) and the outer width (W) are 12.5 mm and 11.5 mm, respectively.
